(19) United States
(12) Patent Application Publication
(10) Pub. No.: US 2026/0344907 A1
(43) Pub. Date: Nov. 5, 2026

(54) SPRING CORE AND METHOD FOR MANUFACTURING A SPRING CORE

(71) Applicant: AGRO Holding GmbH, Bad Essen (DE)

(72) Inventor: Sabine GROTHAUS, Bad Essen (DE)

(73) Assignee: AGRO Holding GmbH, Bad Essen (DE)

(21) Appl. No.: 19/666,511

(22) Filed: May 4, 2026

(30) Foreign Application Priority Data
May 5, 2025 (DE) 10 2025 117 113.0

(51) Int. Cl. A47C 27/07

(52) U.S. Cl. CPC A47C 27/07

(57) ABSTRACT

A spring core includes a plurality of springs arranged in rows, which are covered on an upper side and on a lower side by a textile material, wherein on at least one side a protrusion of the textile material on the top side is connected to a protrusion of the textile material on the lower side, and the springs arranged in rows are arranged compressed within the textile material in at least one spatial direction. This allows the spring core to be used or processed with precise geometry after manufacture.

### CROSS REFERENCE TO RELATED APPLICATIONS

Applicant claims priority under 35 U.S.C. §119 of German Application No. 10 2025 117 113.0 filed May 5, 2025, the disclosure of which is incorporated by reference.

### BACKGROUND OF THE INVENTION

### 1. Field of the Invention

The present invention relates to a spring core comprising a plurality of springs arranged in rows, which are covered on an upper side and a lower side by a textile material, and a method for manufacturing a spring core.

### 2. Description of the Related Art

EP 2 886 018 B1 discloses a mattress with a spring core formed from spring strands, in which the pocketed springs are covered on both sides by a cover layer. A gap is formed between two spring strands so that the mattress can be folded more easily in this area. The cover layers achieve better load distribution; however, inaccuracies may occur when positioning the spring strands between the cover layers, so that the geometry of the mattress is not always exactly the same. For further processing or use of a spring core, an exact geometry of the spring core is desirable.

EP 1 557 116 A1 discloses a cushion with springs enclosed in chambers with walls made of nonwoven fabric. For this purpose, the layers of nonwoven fabric are shaped using embossing tools or deep-drawing tools and directly bonded to one another. However, the positioning of the springs within the chambers is relatively imprecise, and the respective connection of the nonwoven fabric layers around each spring requires a relatively large amount of material.

### SUMMARY OF THE INVENTION

It is therefore the object of the present invention to provide a spring core and a method for manufacturing a spring core, by means of which the spring core can be manufactured with precise geometry and can be easily further processed or used.

This object is solved by a spring core and a method as described below.

A spring core according to the invention comprises a plurality of springs arranged in rows, which are covered on an upper side and on a lower side, respectively, by a textile material. On at least one side of the spring core, a protrusion of the textile material on the upper side is connected to a protrusion of the textile material on the lower side. Furthermore, the springs arranged in a row are compressed within the textile material in at least one spatial direction. By connecting the two textile materials on at least one side, the spring core can be manufactured as a dimensionally stable unit with precise geometry. This facilitates the use or further processing of the spring core.

Preferably, the textile material on the top side is connected to the textile material on the bottom side via a seam in the area of a lateral edge of the spring core. The seam may be produced by welding, gluing, or sewing. If the seam is produced by welding, this is preferably done by ultrasonic welding so that the connection is effectively established.

The textile material on the top side is preferably connected to the textile material on the bottom side via a seam on at least two sides of the spring core. Optionally, the textile material on the top side may also be connected to the textile material on the bottom side on four sides. In this case, the springs are completely surrounded by and enclosed within the textile material. The textile material on the top side is preferably identical to the textile material on the bottom side. Optionally, the textile material on the top side may also be thicker and/or have a higher basis weight than the textile material on the bottom side.

The textile material is preferably formed as a nonwoven or woven fabric. Spunbond or airlaid nonwovens, for example, can be used as nonwovens. In a first embodiment, the textile material may have a relatively low basis weight between 40 and 100 g/m², which is easy to process. In an alternative second embodiment, the textile material preferably has a basis weight of at least 300 g/m², for example between 400 and 600 g/m², so that the spring core with the textile material covering can be used directly as a mattress. In this case, the mattress consists solely of the textile material and the springs enclosed within it. The textile material then serves to distribute the load, providing a uniformly springy structure for the mattress.

In a further embodiment, the textile material is bonded to the springs. In this case, the textile material can be bonded over a large area to the springs, in particular, all springs can be bonded to the textile material to form a particularly dimensionally stable unit. The springs are preferably designed as pocket springs, in which a spring made of wire is enclosed in a pocket of textile material, particularly nonwoven fabric. Instead of pocket springs, Bonell springs and/or open-coil springs may also be used.

The springs may preferably be arranged within the textile material such that they are at least partially compressed in a direction from the top side to the bottom side. This results in a slight preload of the springs against the textile material covering, which improves dimensional stability.

The textile material on the top side of the springs and on the bottom side of the springs is preferably arranged flat in each case. The textile material may be under tension on both the top and bottom sides and is smooth or flat.

In the method according to the invention for manufacturing a spring core, a plurality of springs arranged in rows is first provided, and then a textile material is arranged on an upper side of the springs and a textile material is arranged on a lower side of the springs. A protrusion of the textile material on the top side is then connected to a protrusion on the bottom side on at least one side. The two protrusions are secured to one another via at least one seam, such that on at least one side, preferably on two opposite sides or all four sides, the respective protrusions are connected to one another via a seam. The seam may be formed by welding, gluing, or sewing. The double-layered section with the seam may optionally be attached to an outer or inner side of the spring core cover, for example by gluing or welding.

Preferably, the springs are compressed before the two protrusions are joined, with the at least one seam being formed while the springs are in the compressed position. After the seam is formed, the springs can then expand, optionally pressing against the textile material with a certain amount of preload, so that the spring core thus formed constitutes a dimensionally stable unit.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a perspective view of a spring core according to the invention during manufacture; and

FIG. 2 shows a side view of the spring core of FIG. 1 during manufacture.

### DETAILED DESCRIPTION OF PREFERRED EMBODIMENTS

A spring core 1 comprises a plurality of springs 2 arranged in rows. The springs may be loosely arranged side by side in rows or connected to one another to form spring strands. The springs 2 may, for example, be designed as pocket springs that are connected to one another to form spring strands. Alternatively, the springs 2 may also be designed as Bonell springs and/or open-coil springs.

The springs 2, arranged in rows side by side, are covered on their upper side by a textile material 3 and on their lower side by a textile material 4. The textile material 3 has a length L and a width B that extend beyond the length and width of the cuboid formed by the springs 2, which is essentially rectangular when viewed from above, such that a protrusion 5 of textile material extends beyond the springs 2 in the longitudinal direction. The textile material 4 on the underside of the springs 2 also protrudes, at least in the longitudinal direction, with a protrusion 6. Optionally, corresponding protrusions 5 and 6 may also be provided on the short sides by the respective textile materials 3 and 4.

The textile material 3 and/or 4 is preferably formed from a nonwoven fabric, such as a spunbond, or from a woven fabric. The weight per unit area of the textile material is, for example, between 40 g/m² and 500 g/m². If the weight per unit area exceeds 300 g/m², for example between 400 g/m² and 600 g/m², the spring core 1 can be used directly as a mattress.

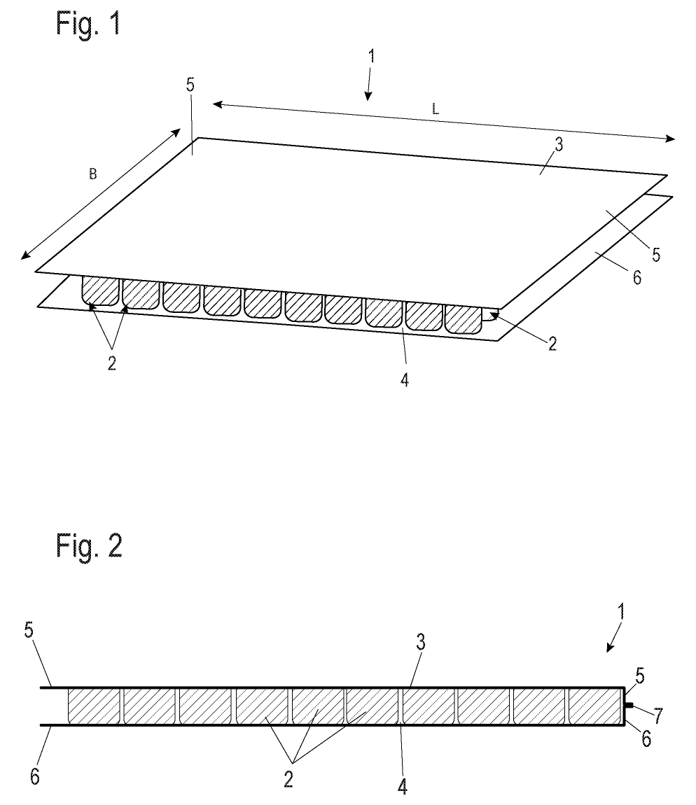

In FIG. 2, the spring core 1 is shown on the left side as in FIG. 1, and on the right side, the two overlapping protrusions 5 and 6 made of textile materials 3 and 4 have been joined together along a seam 7. The seam 7 protrudes from one side of the springs 2 arranged along the edge, but may also be aligned parallel to the longitudinal direction of the springs 2. The seam may be produced by welding, in particular ultrasonic welding, gluing, or sewing. On the opposite side, the textile material 3 and 4 are also joined together in the area of the protrusions 5 and 6. Preferably, the textile material is joined to the textile material 4 on four sides, so that a frame-shaped circumferential seam 7 is provided and the springs 2 are completely enclosed.

Before creating the seam 7, the springs 2 are compressed in at least one spatial direction, for example, the springs 2 can be compressed in a direction perpendicular to the top and bottom surfaces before the protrusions 5 and 6 are joined together. Then, after the respective seam 7 has been formed, the springs 2 can be released, causing them to rest against the inner side of the textile material 3 and 4 with a certain contact pressure.

Preferably, the textile material 3 and 4 is bonded to the springs 2, in particular bonded over the entire surface, so that all springs 2 adhere to the textile material 3 and 4 and form a dimensionally stable unit.

Although only a few embodiments of the present invention have been shown and described, it is to be understood that many changes and modifications may be made thereunto without departing from the spirit and scope of the invention.

### LIST OF REFERENCE SYMBOLS

1 Spring core
2 Spring
3 Textile material
4 Textile material
5 Protrusion
6 Protrusion
7 Seam
B Width
L Length

What is claimed is:

1. A spring core comprising a plurality of springs arranged in rows, which are covered on an upper side and on a lower side by a textile material, wherein, on at least one side, a protrusion of the textile material on the upper side is connected to a protrusion of the textile material on the lower side, and the springs arranged in rows are arranged within the textile material in a compressed state in at least one spatial direction.

2. The spring core according to claim 1, wherein the textile material on the upper side is connected to the textile material on the lower side via a seam in the region of a lateral edge of the spring core.

3. The spring core according to claim 2, wherein the seam is produced by welding, gluing, or sewing.

4. The spring core according to claim 1, wherein the textile material on the upper side is connected to the textile material on the lower side on at least two sides of the spring core via a seam.

5. The spring core according to claim 1, wherein the textile material is formed as a nonwoven fabric or woven fabric.

6. The spring core according to claim 1, wherein the textile material has a weight per unit area of at least 300 g/m².

7. The spring core according to claim 1, wherein the textile material is glued to the springs.

8. The spring core according to claim 1, wherein the springs are configured as pocket springs, Bonell springs, and/or open-coil springs.

9. The spring core according to claim 1, wherein the springs are arranged in the textile material in a compressed state, at least partially in a direction from the upper side to the lower side.

10. The spring core according to claim 1, wherein the textile material is arranged flat on the upper side of the springs and on the lower side of the springs, respectively.

11. A method for manufacturing a spring core comprising the following steps:
providing a plurality of springs arranged in rows,
arranging a textile material on an upper side of the springs,
arranging a textile material on a lower side of the springs,
folding over a protrusion of the textile material on the upper side and a protrusion of the textile material on the lower side at least on one side of the textile materials, and
joining the two protrusions via at least one seam,
wherein the springs, arranged in rows, are arranged compressed within the textile materials in at least one spatial direction.

12. The method according to claim 11, wherein the springs are compressed prior to joining the two protrusions and the at least one seam is formed while the springs are in the compressed position.
